(19) United States
(12) Patent Application Publication
(10) Pub. No.: US 2026/0328995 A1
(43) Pub. Date: Oct. 22, 2026

(54) OPTICAL FIBER

(71) Applicant: LIGHTERA JAPAN CO., LTD., Tokyo (JP)

(72) Inventors: Shugo TAKEUCHI, Tokyo (JP); Kazunori MUKASA, Tokyo (JP); Keiichi AISO, Tokyo (JP); Osanobu FUKUO, Tokyo (JP); Takaaki MINAMIKAWA, Tokyo (JP)

(73) Assignee: LIGHTERA JAPAN CO., LTD., Tokyo (JP)

(21) Appl. No.: 19/702,351

(22) Filed: Jun. 9, 2026

Related U.S. Application Data
(63) Continuation of application No. PCT/JP2024/043819, filed on Dec. 11, 2024.

(30) Foreign Application Priority Data
Dec. 18, 2023 (JP) 2023-213151

(51) Int. Cl. G02B 6/028; G02B 6/02

(52) U.S. Cl. CPC G02B 6/0286; G02B 6/02014

(57) ABSTRACT

An optical fiber includes: a core portion doped with alkali metal or alkaline earth metal in a distribution in a radial direction with a first peak at a center or at a vicinity of the center; and a cladding portion surrounding an outer circumference of the core portion, the cladding portion having an average refractive index lower than a maximum refractive index of the core portion, and being doped with alkali metal or alkaline earth metal in a distribution in a radial direction with at least a second peak in any position in the radial direction.

### CROSS-REFERENCE TO RELATED APPLICATIONS

This application is a continuation of International Application No. PCT/JP2024/043819, filed on Dec. 11, 2024 which claims the benefit of priority of the prior Japanese Patent Application No. 2023-213151, filed on Dec. 18, 2023, the entire contents of which are incorporated herein by reference.

### BACKGROUND

The present disclosure relates to an optical fiber.

To realize next-generation submarine optical communication infrastructure, one of the most important features of optical fibers is the transmission loss. In most of submarine optical fibers, structure relaxation of glass is promoted by adding alkali metal (mainly kalium) to the core portion and an ultra-low transmission loss is enabled by inhibiting Rayleigh scattering and structure disorder (Japanese Laid-open Patent Publication No. 2020-204727, Japanese Patent No. 6615905, Japanese Laid-open Patent Publication No. 2017-27050, Japanese Patent No. 6551109, Japanese Laid-open Patent Publication No. 2020-12933, Japanese Patent No. 7119531, Japanese Patent No. 6536036, Japanese Patent No. 5706374, and Japanese National Publication of International Patent Application No. 2008-536190).

### SUMMARY

Further reduction is demanded in the transmission loss of optical fibers beyond submarine optical fibers.

According to one aspect of the present disclosure, there is provided an optical fiber including: a core portion doped with alkali metal or alkaline earth metal in a distribution in a radial direction with a first peak at a center or at a vicinity of the center; and a cladding portion surrounding an outer circumference of the core portion, the cladding portion having an average refractive index lower than a maximum refractive index of the core portion, and being doped with alkali metal or alkaline earth metal in a distribution in a radial direction with at least a second peak in any position in the radial direction.

### BRIEF DESCRIPTION OF THE DRAWINGS

FIG. 1 is a schematic cross-sectional view of an optical fiber according to a first embodiment;

FIG. 2A is a diagram illustrating an example of a refractive index profile of the optical fiber illustrated in FIG. 1;

FIG. 2B is a diagram illustrating an example of the refractive index profile of the optical fiber illustrated in FIG. 1;

FIG. 2C is a diagram illustrating an example of the refractive index profile of the optical fiber illustrated in FIG. 1;

FIG. 3A is a graph illustrating the kalium additive amount in a radial direction of the optical fiber illustrated in FIG. 1;

FIG. 3B is a graph illustrating the fictive temperature in the radial direction of the optical fiber illustrated in FIG. 1;

FIG. 4 is a schematic cross-sectional view of an optical fiber according to a second embodiment;

FIG. 5A is a graph illustrating the kalium additive amount in a radial direction of the optical fiber illustrated in FIG. 4;

FIG. 5B is a graph illustrating the fictive temperature in the radial direction of the optical fiber illustrated in FIG. 4;

FIG. 6 is a schematic cross-sectional view of an optical fiber according to a third embodiment;

FIG. 7A is a graph illustrating the kalium additive amount in a radial direction of the optical fiber illustrated in FIG. 6; and

FIG. 7B is a graph illustrating a fictive temperature in the radial direction of the optical fiber illustrated in FIG. 6.

### DETAILED DESCRIPTION

With reference to the accompanying drawings, embodiments of the present disclosure will be described in detail below. Note that the embodiments described below do not limit the present disclosure. In each of the drawings, the same or corresponding components are denoted with the same reference numerals appropriately and thus redundant description is omitted appropriately. In the specification, a cut-off wavelength or an effective cut-off wavelength refers to a cable cut-off wavelength (Acc) that is defined by ITU-T G.650.1 of International Telecommunication Union (ITU). Other terms that are not particularly defined in the specification comply with definitions and measurement methods according to G.650.1 and G.650.2.

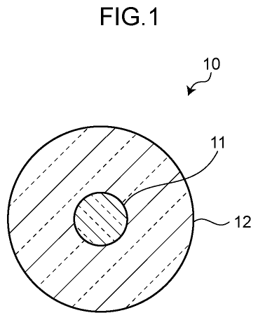

FIG. 1 is a schematic cross-sectional view of an optical fiber according to a first embodiment. An optical fiber 10 is made of silica glass and includes a core portion 11 and a cladding portion 12.

The core portion 11 has a cross-section that is approximately circular and the core portion 11 is positioned approximately at the center of the cladding portion 12 having a cross-section that is approximately circular. The cladding portion 12 surrounds an outer circumference of the core portion 11. A maximum refractive index of the core portion 11 is higher than an average refractive index of the cladding portion 12. Note that the average refractive index of the cladding portion 12 is an average refractive index of the cladding portion 12 in a radial direction.

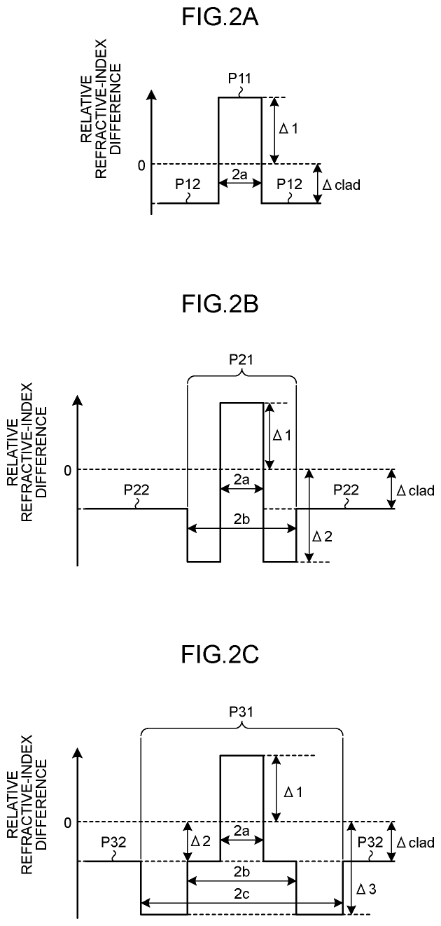

The optical fiber 10 has, for example, a refractive index profile like that illustrated in FIGS. 2A to 2C. FIGS. 2A to 2C all illustrate a refractive index profile of the optical fiber 10 in a radial direction from a center axis of the core portion 11. Note that the refractive index profile is represented by a relative refractive-index difference with respect to pure fused quartz. The pure fused quartz is highly-pure fused quartz that does not contain a dopant that varies the refractive index and that has a refractive index of approximately 1.444 at a wavelength 1550 nm.

FIG. 2A illustrates a step-type refractive index profile. In FIG. 2A, a profile P11 represents a refractive index profile of the core portion 11 and a profile P12 represents a refractive index profile of the cladding portion 12. In the step-type refractive index profile, the diameter of the core portion 11 is 2a and the relative refractive-index difference of the maximum refractive index (maximum relative refractive-index difference) of the core portion 11 is Δ1. The relative refractive-index difference of the average refractive index of the cladding portion 12 with respect to the refractive index of pure fused quartz is Δclad.

FIG. 2B illustrates what is referred to as a W-type refractive index profile. In FIG. 2B, a profile P21 represents a refractive index profile of the core portion 11 and a profile P22 represents a refractive index profile of the cladding portion 12. In the W-type refractive index profile, the core portion 11 includes a center core whose diameter is 2a and a depressed layer that is formed such that the depressed layer surrounds an outer circumference of the center core, whose refractive index is smaller than a refractive index of the cladding portion, whose inner diameter is 2a, and whose outer diameter is 2b. The center core is a portion whose average refractive index is the largest in the core portion 11. The maximum relative refractive-index difference of the center core with respect to the refractive index of pure fused quartz is Δ1. A relative refractive-index difference of an average refractive index of the depressed layer with respect to the refractive index of pure fused quartz is Δ2. The relative refractive-index difference of the average refractive index of the cladding portion 12 with respect to the refractive index of pure fused quartz is Δclad.

FIG. 2C illustrates what is referred to as a trench-type refractive index profile. In FIG. 2C, a profile P31 represents a refractive index profile of the core portion 11 and a profile P32 represents a refractive index profile of the cladding portion 12. In the trench-type refractive index profile, the core portion 11 includes a center core whose diameter is 2a; an intermediate layer that is formed such that the depressed layer surrounds an outer circumference of the center core, whose refractive index is smaller than a maximum refractive index of the cladding portion 12, whose inner diameter is 2a, and whose outer diameter is 2b; and a trench layer that is formed such that the trench layer surrounds an outer circumference of the intermediate layer, whose refractive index is smaller than a refractive index of the cladding portion 12, whose inner diameter is 2b, and whose outer diameter is 2c. The center core is a portion whose average refractive index is the largest in the core portion 11. The maximum relative refractive-index difference of the center core with respect to the refractive index of pure fused quartz is Δ1. The relative refractive-index difference of the intermediate layer with respect to the refractive index of pure fused quartz is Δ2. The relative refractive-index difference of the trench layer with respect to the refractive index of pure fused quartz is Δ3. The relative refractive-index difference of the average refractive index of the cladding portion 12 with respect to the refractive index of pure fused quartz is Δclad. Note that, in general, Δ2 is set at or around the same value as Δclad.

Constituent materials of the core portion 11 and the cladding portion 12 of the optical fiber 10 will be described next. The core portion 11 in the case where the refractive index profile is the step-type and the center core in the core portion 11 in the case where the refractive index profile is the W-type or the trench-type are made of silica glass to which chlorine (Cl) is doped and to which alkali metal or alkaline earth metal is doped. For example, kalium (K) or sodium (Na) is exemplified as the alkali metal, and K is the most preferable in manufacturing in consideration of dopant control based on a diffusion coefficient and costs. Cl, alkali metal and alkaline earth metal are dopants that increase the refractive index of silica glass. A dopant that lowers the refractive index may be doped to the core portion 11 and the center core. The dopant that lowers the refractive index is, for example, fluorine (F).

The depressed layer and the trench layer in the core portion 11 in the case where the refractive index profile is the W-type or the trench-type are made of silica glass to which alkali metal or alkaline earth metal is doped and to which a dopant that lowers the refractive index is doped. Cl may be doped to the depressed layer or the trench layer. In other words, at least one of F and Cl may be doped to the core portion 11.

The cladding portion 12 is also made of silica glass to which alkali metal or alkaline earth metal is doped and to which a dopant that lowers the refractive index is doped. The intermediate layer is made of silica glass whose components are the same as or similar to those of the cladding portion 12. At least one of F and Cl may be doped to the cladding portion 12.

The dopants described above are doped in various additive amounts that realize preferred refractive index profiles.

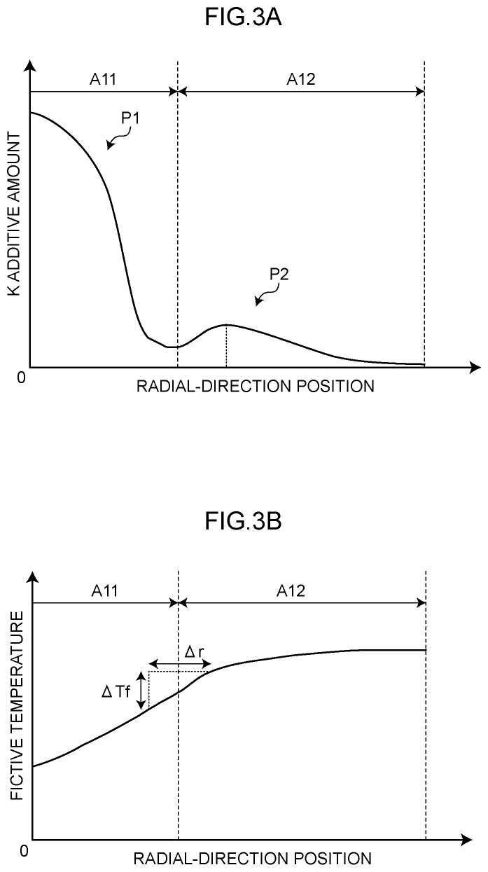

A distribution of an additive amount of alkali metal or alkaline earth metal in the optical fiber 10 will be described next by exemplifying the case where the alkali metal or the alkaline earth metal is K. FIGS. 3A and 3B are graphs illustrating the additive amount of kalium (K additive amount) or a fictive temperature in the radial direction of the optical fiber 10 illustrated in FIG. 1. FIG. 3A illustrates the relationship between the position in the radial direction with respect to the center of the optical fiber 10 and the K additive amount and FIG. 3B illustrates the relationship between the position in the radial direction with respect to the center of the optical fiber 10 and the fictive temperature. In FIGS. 3A and 3B, an area A11 is an area corresponding to the core portion 11 and an area A12 is an area corresponding to the cladding portion 12.

As illustrated in FIG. 3A, to the core portion 11, K is doped in a distribution in the radial direction with a first peak P1 at or near the center. To the cladding portion 12, K is doped in a distribution in the radial direction with a second peak P2 in a position in the radial direction indicated by a dotted line. A peak value of the first peak P1 is larger than a peak value of the second peak P2.

In the optical fiber 10, K is doped in the distribution in the radial direction with the first peak P1 to the core portion 11 and K is doped in the distribution in the radial direction with the second peak P2 also to the cladding portion 12. Accordingly, compared to the case where K is doped in a distribution in the radial direction with a peak only in the core portion, an overall distribution of a fictive temperature in the radial direction is smooth as illustrated in FIG. 3B. As a result, a stress difference inside the optical fiber 10 is reduced and the transmission loss due to viscosity mismatch is inhibited from lowering. This makes it possible to further reduce the transmission loss of the optical fiber 10.

In the optical fiber 10, because the peak value of the first peak P1 is larger than the peak value of the second peak P2, the viscosity mismatch is further reduced in the core portion 11 than in the cladding portion 12. As a result, it is possible to reduce the transmission loss of the optical fiber 10 more effectively. For example, the peak value of the second peak P2 may be 95% of the peak value of the first peak P1 or smaller.

Smoothness of the distribution of the fictive temperature in the radial direction can be represented by a slope of the distribution of the fictive temperature in the radial direction. For example, FIG. 3B illustrates a change in the fictive temperature by a variation ΔTf at the time when the radial-direction position shifts by Δr and the slope of the distribution curve of the fictive temperature is represented by (ΔTf/Δr). The slope of the distribution curve of the fictive temperature may be represented by a differential coefficient like dTf/dr using the fictive temperature Tf as a function of the radial-direction position r.

According to the intensive studies by the inventors, when the maximum value of the slope of the distribution of the fictive temperature in the radial direction is 4 °C/μm or smaller, the distribution of the fictive temperature in the radial direction is smooth and it is possible to further reduce the transmission loss of the optical fiber 10. Note that, because the maximum value of the slope of the distribution of the fictive temperature in the radial direction often occurs at the boundary between the core portion 11 and the cladding portion 12, it is preferable that the slope of the distribution of the fictive temperature at the boundary between the core portion 11 and the cladding portion 12 be 4 °C/μm or smaller.

The fictive temperature of silica glass can be calculated using a Raman scattering spectrum. It has been known that a ratio D2/ω3 of a Raman peak (D2 peak) resulting from a three-membered ring structure in silica glass and a Raman peak (ω3 peak) resulting from a Si—O—Si bending vibration corresponds to the fictive temperature of silica glass. Thus, a fictive temperature can be calculated by generating a calibration curve on D2/ω3 using the Raman scattering spectrum of silica glass whose fictive temperature is known and by using the calibration curve (For example, refer to Hasegawa, Takemi, et al. (2018, January) SEI Technical Review, (No. 192), pp. 14-19).

According to the known technique, alkali metal or alkaline earth metal is doped intentionally only to a core portion of an optical fiber. Contrary to this, the inventors reached that it is possible to have the slope of the distribution of the fictive temperature at 4 °C/μm or smaller by adding alkali metal or alkaline earth metal not only to a core portion but also to a cladding portion intentionally.

As described above, in the optical fiber 10 according to the first embodiment, the transmission loss is further reduced.

Note that it is possible to manufacture the optical fiber 10 according to the first embodiment, for example, in the following manner. First of all, a core preform serving as an original material of the core portion 11 is manufactured by a known method of manufacturing a glass preform such as VAD (Vapor phase Axial Deposition) or MCVD (Modified Chemical Vapor Deposition). In the manufacturing, alkali metal or alkaline earth metal and various types of dopants for realizing a preferred refractive index profile are doped to the core preform by a known method such as a gas phase method.

A jacket tube serving as an original material of the cladding portion 12 is manufactured next. It is possible to manufacture the jacket tube, for example, by adding alkali metal or alkaline earth metal to a glass tube made of silica glass to which a preferred dopant is doped and by increasing the diameter of a hole of the glass tube with a drill or the like to a size such that the core preform is insertable into the hole. Thereafter, the core preform is inserted into the jacket tube and the jacket tube and the core preform are heated and integrated into an optical fiber preform. It is possible to manufacture the optical fiber 10 according to the first embodiment by applying a drawing method using a known drawing furnace to the optical fiber preform.

Note that it is possible to form the distribution of the additive amount and the distribution of the fictive temperature like those illustrated in FIG. 3A by adjusting the distributions of the additive amounts in the core preform and the jacket tube, by adjusting a thermal processing temperature and a thermal processing time at the time of heating and integration, and by adjusting a drawing condition. Particularly, to have the maximum value of the slope of the distribution curve of the fictive temperature in the radial direction of the optical fiber at 4 °C/μm or smaller, it is preferable to promote relaxation of a glass structure by performing optimization of a cooling gas condition or annealing in order to inhibit rapid cooling in the optical fiber that comes out of the drawing furnace.

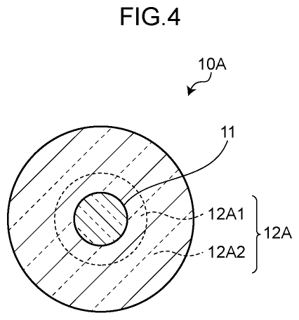

FIG. 4 is a schematic cross-sectional view of an optical fiber according to a second embodiment. An optical fiber 10A is made of silica glass and includes the core portion 11 and a cladding portion 12A.

The core portion 11 is the same as the core portion 11 of the optical fiber 10 according to the first embodiment, and thus description thereof will be omitted.

The cladding portion 12A includes an inner layer 12A1 that surrounds the outer circumference of the core portion 11 and an outer layer 12A2 that surrounds an outer circumference of the inner layer 12A1. A maximum refractive index of the core portion 11 is higher than an average refractive index of the cladding portion 12A. Note that the average refractive index of the cladding portion 12A is an average refractive index of the cladding portion 12A in a radial direction. An average refractive index of the inner layer 12A1 and an average refractive index of the outer layer 12A2 are approximately equal. The cladding portion 12A is also made of silica glass to which alkali metal or alkaline earth metal is doped and to which a dopant that lowers the refractive index is doped. At least one of F and Cl is doped to the cladding portion 12A.

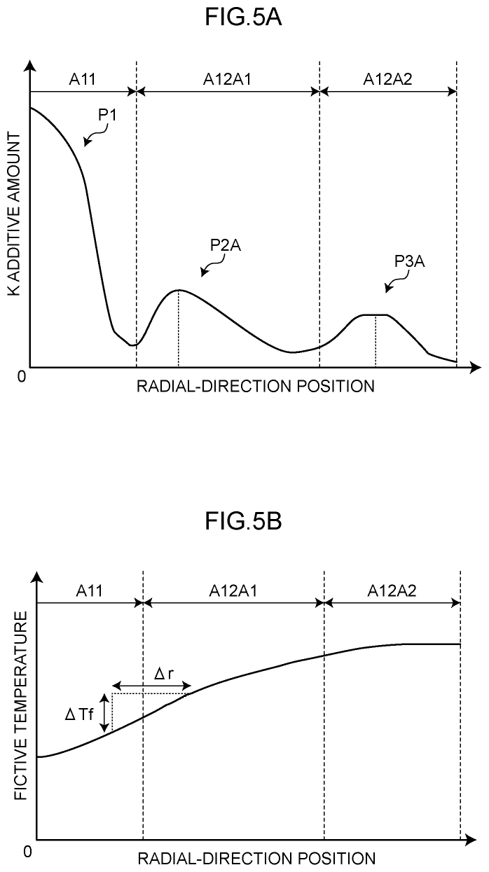

A distribution of an additive amount of alkali metal or alkaline earth metal in the optical fiber 10A will be described next by exemplifying the case where the alkali metal or the alkaline earth metal is K. FIGS. 5A and 5B are graphs illustrating the K additive amount or the fictive temperature in the radial direction of the optical fiber 10A illustrated in FIG. 4. FIG. 5A illustrates the relationship between the position in the radial direction with respect to the center of the optical fiber 10A and the K additive amount and FIG. 5B illustrates the relationship between the position in the radial direction with respect to the center of the optical fiber 10A and the fictive temperature. In FIGS. 5A and 5B, an area A11 is an area corresponding to the core portion 11, an area A12A1 is an area corresponding to the inner layer 12A1 of the cladding portion 12A, and an area A12A2 is an area corresponding to the outer layer 12A2 of the cladding portion 12A.

As illustrated in FIG. 5A, to the core portion 11, K is doped in a distribution in the radial direction with a first peak P1 at or near the center. To the inner layer 12A1 of the cladding portion 12A, K is doped in a distribution in the radial direction with a second peak P2A in a position in the radial direction indicated by the dotted line. To the outer layer 12A2 of the cladding portion 12A, K is doped in a distribution in the radial direction with a second peak P2A in a position that is indicated by the dotted line and that is separated from the second peak P2A in the radial direction. A peak value of the first peak P1 is larger than a peak value of the second peak P2A and a peak value of the second peak P2A is larger than a peak value of the third peak P3A. For example, the peak value of the second peak P2A may be 95% of the peak value of the first peak P1 or smaller. For example, the peak value of the third peak P3A may be 90% of the peak value of the first peak P1 or smaller.

In the optical fiber 10A, K is doped in the distribution in the radial direction with the third peak P3A also in the outer layer 12A2 of the cladding portion 12A in addition to the first peak P1 in the core portion 11 and the second peak P2A in the inner layer 12A1 of the cladding portion 12A. Accordingly, the distribution of the fictive temperature in the radial direction is further smooth as illustrated in FIG. 5B. As a result, it is possible to further reduce the transmission loss of the optical fiber 10A.

In the optical fiber 10A, because the peak value of the first peak P1 is larger than the peak value of the second peak P2A, the viscosity mismatch is further reduced in the core portion 11 than in the cladding portion 12A. As a result, it is possible to reduce the transmission loss of the optical fiber 10A more effectively. The third peak P3A whose peak value is smaller is in the position separated from the second peak P2A in the radial direction and accordingly the viscosity mismatch over the cladding portion 12A in the radial direction is mitigated more preferably.

As described above, in the optical fiber 10A according to the second embodiment, the transmission loss is further reduced.

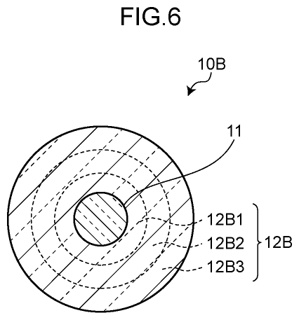

FIG. 6 is a schematic cross-sectional view of an optical fiber according to a third embodiment. An optical fiber 10B is made of silica glass and includes the core portion and a cladding portion 12B.

The core portion 11 is the same as the core portion 11 of the optical fiber 10 according to the first embodiment, and thus description thereof will be omitted.

The cladding portion 12B includes an inner layer 12B1 that surrounds the outer circumference of the core portion 11, an intermediate layer 12B2 that surrounds an outer circumference of the inner layer 12B1, and an outer layer 12B3 that surrounds an outer circumference of the intermediate layer 12B2. A maximum refractive index of the core portion 11 is higher than an average refractive index of the cladding portion 12B. Note that the average refractive index of the cladding portion 12B is an average refractive index of the cladding portion 12B in a radial direction. An average refractive index of the inner layer 12B1, an average refractive index of the intermediate layer 12B2, and an average refractive index of the outer layer 12B3 are approximately equal to each other. The cladding portion 12B is also made of silica glass to which alkali metal or alkaline earth metal is doped and to which a dopant that lowers the refractive index is doped. At least one of F and Cl is doped to the cladding portion 12B.

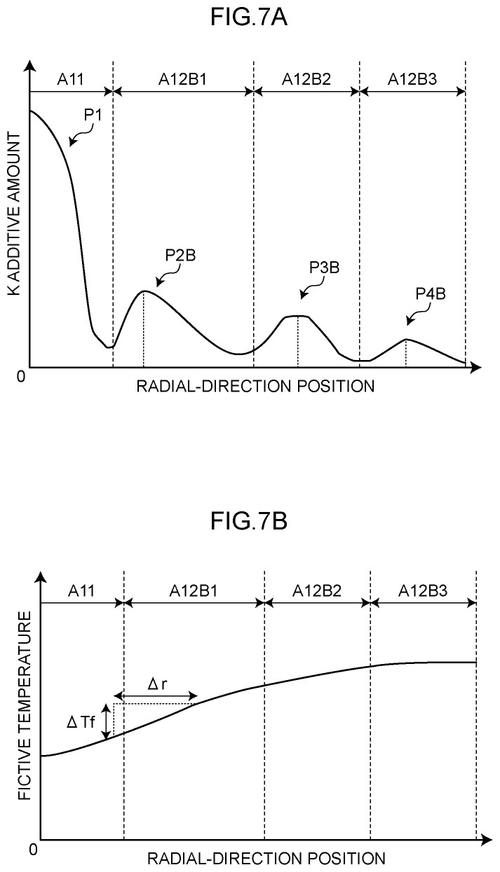

A distribution of an additive amount of alkali metal or alkaline earth metal in the optical fiber 10B will be described next by exemplifying the case where the alkali metal or the alkaline earth metal is K. FIGS. 7A and 7B are graphs illustrating the K additive amount or the fictive temperature in the radial direction of the optical fiber 10B illustrated in FIG. 6. FIG. 7A illustrates the relationship between the position in the radial direction with respect to the center of the optical fiber 10B and the K additive amount and FIG. 7B illustrates the relationship between the position in the radial direction with respect to the center of the optical fiber 10B and the fictive temperature. In FIGS. 7A and 7B, an area A11 is an area corresponding to the core portion 11, an area A12B1 is an area corresponding to the inner layer 12B1 of the cladding portion 12B, an area A12B2 is an area corresponding to the intermediate layer 12B2 of the cladding portion 12B, and an area A12B3 is an area corresponding to the outer layer 12B3 of the cladding portion 12B.

As illustrated in FIG. 7A, to the core portion 11, K is doped in a distribution in the radial direction with a first peak P1 at or near the center. To the inner layer 12B1 of the cladding portion 12B, K is doped in a distribution in the radial direction with a second peak P2B in a position in the radial direction indicated by the dotted line. To the intermediate layer 12B2 of the cladding portion 12B, K is doped in a distribution in the radial direction with a third peak P3B in a position that is indicated by the dotted line and that is separated from the second peak P2B in the radial direction. To the outer layer 12B3 of the cladding portion 12B, K is doped in a distribution in the radial direction with a fourth peak P4B in a position that is indicated by the dotted line and that is separated from the third peak P3B in the radial direction. A peak value of the first peak P1 is larger than a peak value of the second peak P2B, a peak value of the second peak P2B is larger than a peak value of the third peak P3B, and a peak value of the third peak P3B is larger than a peak value of the fourth peak P4B.

In the optical fiber 10B, K is doped in the distribution in the radial direction with the first peak P1 in the core portion 11, the second peak P2B in the inner layer 12B1 of the cladding portion 12B, a third peak P3B in the intermediate layer 12B2 of the cladding portion 12B, and a fourth peak 4B in the outer layer 12B3 of the cladding portion 12B. Accordingly, the distribution of the fictive temperature in the radial direction is further smooth as illustrated in FIG. 7B. As a result, it is possible to further reduce the transmission loss of the optical fiber 10B.

In the optical fiber 10B, because the peak value of the first peak P1 is larger than the peak value of the second peak P2B, the viscosity mismatch is further reduced in the core portion 11 than in the cladding portion 12B. As a result, it is possible to reduce the transmission loss of the optical fiber 10B more effectively. The third peak P3B whose peak value is smaller is in the position separated from the second peak P2B in the radial direction and furthermore there is the fourth peak P4B whose peak value is smaller and accordingly the viscosity mismatch over the cladding portion 12B in the radial direction is mitigated more preferably.

As described above, in the optical fiber 10B according to the third embodiment, the transmission loss is further reduced.

Note that it is possible to manufacture the optical fibers 10A and 10B according to the second and third embodiments by a method similar to that for manufacturing the optical fiber 10 according to the above-described first embodiment. For example, to manufacture the optical fiber 10A, a first jacket tube serving as an original material of the inner layer 12A1 of the cladding portion 12A and a second jacket tube serving as an original material of the outer layer 12A2 are manufactured. A core preform is inserted into the first jacket tube, the core preform and the first jacket tube are inserted into the second jacket tube, the first jacket tube, the core preform, and the second jacket tube are heated and integrated into an optical fiber preform.

The optical fibers illustrated below were examined by simulated calculation as optical fibers of Comparative Example 1 and Examples 1 to 6 of the present disclosure.

The optical fiber of Comparative Example 1 has a W-type refractive index profile and, to the optical fiber, K is doped in a distribution in a radial direction with a peak in only a core portion.

To the optical fibers of Examples 1 and 2, K is doped in a distribution in a radial direction with a first peak in a core portion and a second peak in a cladding portion as in the first embodiment. Optical fibers of Examples 1 and 2 have trench-type refractive-index profiles. Note that the value of the second peak was 500 ppm or smaller.

To the optical fibers of Examples 3 and 4, K is doped in a distribution in a radial direction with a first peak in a core portion and a second peak and a third peak in a cladding portion as in the second embodiment. The optical fibers of Examples 3 and 4 have W-type refractive index profiles. Note that the values of the second and third peaks were 500 ppm or smaller.

To the optical fibers of Examples 5 and 6, K is doped in a distribution in a radial direction with a first peak in a core portion and a second peak, a third peak, and a fourth peak in a cladding portion as in the third embodiment. The optical fibers of Examples 5 and 6 have W-type refractive index profiles. Note that the values of the second, third, and fourth peaks were 500 ppm or smaller.

Table 1 presents the structural parameters (Δ1[%], Δ2[%], Δ3[%], and 2a[μm]), the maximum values [° C/μm] of a slope (dTf/dr) of a distribution curve of a fictive temperature, the effective core cross-sectional areas (Aeff) [μm²] at a wavelength of 1.55 μm, the transmission losses, and the cut-off wavelengths [nm] of the optical fibers of Examples 1 to 6. As presented in Table 1, while the maximum value of dTf/dr was larger than 4 °C/μm and the transmission loss was relatively large at 0.175 dB/km in the optical fiber of Comparative Example 1, the maximum value of dTf/dr was 4 °C/μm or smaller and the transmission loss was relatively small at 0.174 dB/km or smaller in the optical fibers of Examples 1 to 6. Particularly, the transmission loss was 0.164 dB/km or smaller in the optical fibers of Examples 3 to 6 with a third peak and the transmission loss was 0.154 dB/km or smaller in the optical fibers of Examples 5 and 6 with a fourth peak.

TABLE 1

| | | | | | Maximum | | Transmission | |
|---|---|---|---|---|---|---|---|---|
| | | | | | value of | | loss @1.55 | Cutoff |
| | | | | | dTf/dr | Aeff | μm | wavelength |
| | Δ1 | 2a | Δ2 | Δ3 | [°C/μm] | [μm] | [dB/km] | [nm] |
| Comparative | 0.27 | 12.5 | −0.11 | — | 7.5 | 113 | 0.175 | 1492 |
| example 1 | | | | | | | | |
| Example 1 | 0.37 | 8.6 | 0.04 | −0.14 | 3.8 | 80.3 | 0.174 | 1218 |
| Example 2 | 0.38 | 8.2 | 0.05 | −0.13 | 3.8 | 71.9 | 0.168 | 1204 |
| Example 3 | 0.27 | 13.3 | −0.25 | — | 3.5 | 111 | 0.164 | 1439 |
| Example 4 | 0.27 | 11.1 | −0.11 | — | 3.5 | 101 | 0.164 | 1290 |
| Example 5 | 0.27 | 12.5 | −0.08 | — | 3.3 | 117 | 0.154 | 1463 |
| Example 6 | 0.25 | 13.5 | −0.02 | — | 3.3 | 140 | 0.151 | 1490 |

In the optical fibers of Examples 1 to 6, the effective core cross-sectional area was between 70 μm² and 180 μm², inclusive. When the effective core cross-sectional area at the wavelength of light that is input is between 70 μm² and 180 μm², inclusive, as described above, it is preferable in view of compatibility with many of conventional optical fibers. Particularly, in terms of inhibition of non-linear optical effects, the effective core cross-sectional area is preferably between 100 μm² and 180 μm², inclusive, and is more preferably between 140 μm² and 180 μm², inclusive.

The optical fibers of Examples 1 to 6 has the cut-off wavelength of 1530 nm or smaller and enables single-mode transmission of light of the C-band (for example, between the wavelengths of 1530 nm and 1565 nm) and light of the L-band (for example, between the wavelengths of 1565 nm to 1625 nm).

The above-described embodiments present the examples with one peak in a core of an optical fiber and three peaks at maximum in a cladding and, not limited to this, there may be a larger number of peaks. In this case, a n-th peak value (n is a natural number) from the inner side may be a value larger than a n+1-th peak value.

The interval between the peaks is not particularly limited and a configuration in which the interval between the peaks in the radial direction is 40 μm or smaller and more preferably is 20 μm or smaller is preferable because it leads to a more gradual change in the fictive temperature of a cladding area.

According to the present disclosure, it is possible to achieve optical fibers with further reduced transmission loss.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical fiber comprising:
a core portion doped with alkali metal or alkaline earth metal in a distribution in a radial direction with a first peak at a center or at a vicinity of the center; and
a cladding portion surrounding an outer circumference of the core portion, the cladding portion having an average refractive index lower than a maximum refractive index of the core portion, and being doped with alkali metal or alkaline earth metal in a distribution in a radial direction with at least a second peak in any position in the radial direction.

2. The optical fiber according to claim 1, wherein a maximum value of a slope of a distribution curve of a fictive temperature in the radial direction is 4 °C/μm or smaller.

3. The optical fiber according to claim 1, wherein the cladding portion is further doped with alkali metal or alkaline earth metal in a distribution in the radial direction with a third peak in a position separated from the second peak in the radial direction.

4. The optical fiber according to claim 3, wherein the cladding portion is further doped with alkali metal or alkaline earth metal in a distribution with a fourth peak in the radial direction in a position separated from the third peak in the radial direction.

5. The optical fiber according to claim 3, wherein an interval between the peaks that are adjacent to each other in the radial direction is 40 μm or smaller.

6. The optical fiber according to claim 5, wherein the interval is 20 μm or smaller.

7. The optical fiber according to claim 1, wherein the alkali metal is kalium.

8. The optical fiber according to claim 1, wherein the core portion is doped with at least one of fluorine or chlorine.

9. The optical fiber according to claim 1, wherein a peak value of the first peak is larger than a peak value of the second peak.

10. The optical fiber according to claim 3, wherein a peak value of the first peak is larger than a peak value of the second peak, and
a peak value of the second peak is larger than a peak value of the third peak.

11. The optical fiber according to claim 10, wherein
a peak value of the second peak is 95% of the peak value of the first peak or smaller, and
a peak value of the third peak is 90% of the peak value of the first peak or smaller.

12. The optical fiber according to claim 4, wherein
a peak value of the first peak is larger than a peak value of the second peak,
the peak value of the second peak is larger than a peak value of the third peak, and
the peak value of the third peak is larger than a peak value of the fourth peak.

13. The optical fiber according to claim 1, wherein an effective core cross-sectional area at a wavelength of input light is 70 μm² to 180 μm².

14. The optical fiber according to claim 1, wherein an effective core cross-sectional area at a wavelength of input light that is 100 μm² to 180 μm².

15. The optical fiber according to claim 1, wherein an effective core cross-sectional area at a wavelength of input light is 140 μm² to 180 μm².

16. The optical fiber according to claim 1, wherein a transmission loss at a wavelength of 1550 nm is 0.174 dB/km or smaller.

17. The optical fiber according to claim 1, wherein a transmission loss at a wavelength of 1550 nm is 0.164 dB/km or smaller.

18. The optical fiber according to claim 1, wherein a transmission loss at a wavelength of 1550 nm is 0.154 dB/km or smaller.

19. The optical fiber according to claim 1, wherein a cut-off wavelength is 1530 nm or smaller.

20. The optical fiber according to claim 1, wherein the cladding portion is doped with at least one of fluorine or chlorine.
